(19) United States
(12) Patent Application Publication
(10) Pub. No.: US 2017/0287037 A1
(43) Pub. Date: Oct. 5, 2017

(54) ELECTRONIC METHODS AND SYSTEMS FOR BIDDING ON MANUAL SERVICES

(71) Applicant: Guowang Miao, Conroe, TX (US)

(72) Inventor: Guowang Miao, Conroe, TX (US)

(21) Appl. No.: 15/469,140

(22) Filed: Mar. 24, 2017

Related U.S. Application Data
(60) Provisional application No. 62/315,017, filed on Mar. 30, 2016.

(51) Int. Cl. G06Q 30/06; G06Q 20/28; G06Q 30/08

(52) U.S. Cl. CPC G06Q 30/0611; G06Q 30/08; G06Q 20/28

(57) ABSTRACT

The present invention relates to method(s) and system(s) for providing manual services over a computer network. The method implemented in a system is configured to receive service request information from a service requester; send processed service request information to potential service providers; receive security deposit and service bid information from said service providers for said service request; send processed service bid information to said service requester; and receive selection result of service provider from said service requester.

### FIELD OF THE INVENTION

The present invention in general relates to online bidding; more particularly, the invention relates to methods and systems for bidding and mediation on services over a computer network.

### BRIEF DESCRIPTION OF THE FIGS.

Various embodiments are described in detail with reference to the following figures. The drawings are provided for purposes of illustration only and merely depict some embodiments. These drawings shall not be considered limiting of the breadth, scope, or applicability of embodiments. In the figures, the left-most digit(s) of a reference number identifies the figure in which the reference number first appears. The use of the same reference number in different figures indicates similar or identical items.

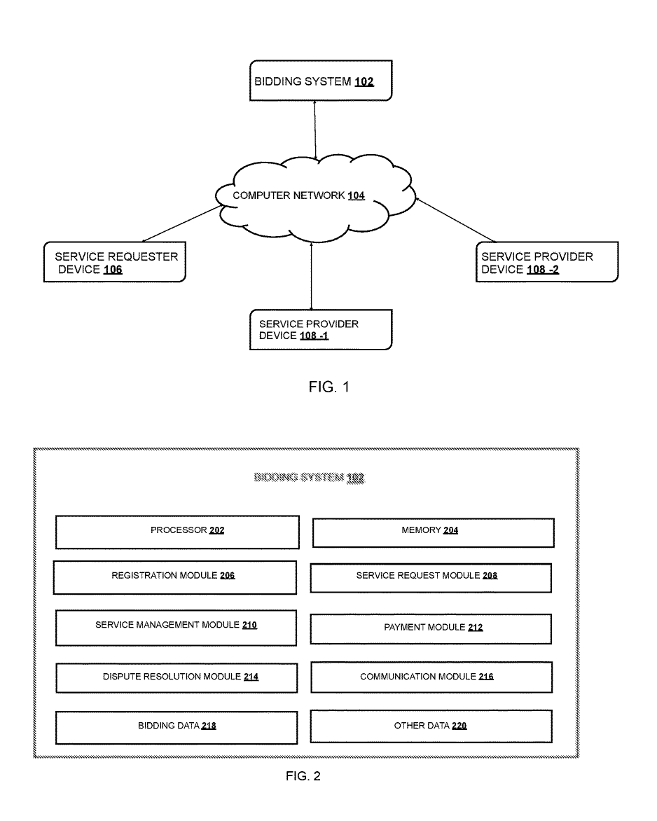

FIG. 1 is a network diagram illustrating example network system that may be used with various embodiments.

FIG. 2 is a block diagram illustrating a bidding system, in accordance with an embodiment of the present subject matter.

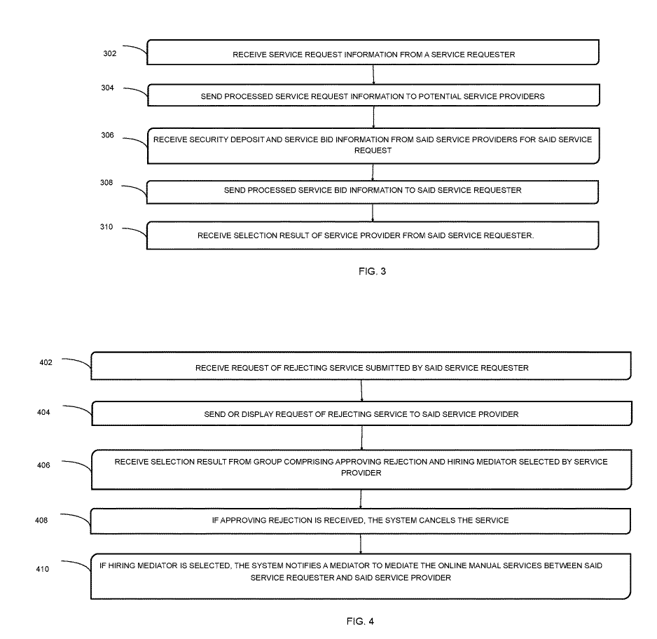

FIG. 3 is a flowchart illustrating a method for managing bid process for a desired service in accordance with an embodiment of the present subject matter.

FIG. 4 is a flowchart mediating disputes for online manual services between a service requester and a service provider, in accordance with an embodiment of the present subject matter.

### DETAILED DESCRIPTION OF INVENTION

Various embodiments described herein provide for systems and methods that provide online manual services. The online manual services can be selected from all the manual services which can be provided online. Several examples of online manual services are translation, editing, writing, logo design, voice over, voice casting, video production, movie production, whose service content can be digitalized and delivered using computer networks. The online manual service may be interchangeably used with the word service throughout the draft. The embodiments herein disclosed, manage or facilitate bidding process between a service requester and a service provider for a service.

In one embodiment of the invention, a method of conducting a bid on a service is proposed, the method comprises the steps of a) receiving service requests and payment from a customer that requests a service; b) displaying the service request to potential service providers; c) receiving service bids and security deposits from said service providers; d) displaying bids to said customer; e) receiving selection result of service provider from said customer. The service request from a customer can be a description of what kind of service the customer requests. For example, it can be translation service from English to Japanese. It may also include the information of how many words there are in the translation. The payment from said customer can be done in any format. For example, the payment can be a check payment, a wire transfer, cash payment, credit card payment, and so on. The payment can also be done through credit transfer inside the online system, where the credits are prepaid credits. The display of the service request to potential service providers can be of any format, e.g. display through mobile apps or website. The information displayed to potential service providers is processed and can be the same as or part of those in the service request. The information displayed to potential service providers can also be variations of the information in the service request. The service bids received from said service providers are mainly the bidding statement, messages, materials, or any information about the service providers. A service bid indicates that the service provider is willing to provider service. The security deposit from said service provider is a deposit of money to ensure that the service provider will perform the services and take related responsibilities. The security deposit can be paid in any format. For example, the payment can be a check payment, a wire transfer, cash payment, credit card payment, and so on. The security deposit can also be paid through credit transfer inside the online system, where the credits are prepaid credits. The displaying of bids to said customer means displaying the interests of service providers to provide the service. The material and information of the bidding service providers may also be displayed to said customers. The selection result of service provider from said customer is the decision from the customer about which service providers are selected to provide the service.

In another embodiment of the invention, a method of enabling bid on manual services is proposed, the method comprises the steps of a) receiving service requests and payments from a customer that requests a service; b) sending service requests to one or more service systems so that potential service providers can see said service requests; c) receiving service bids and security deposits from said one or more service systems; d) displaying bids to said customer e) receiving selection result of service providers from said customer; f) sending the selection result to said one or more service systems. Here, the service system can be a computer system or computer network that connects with service providers.

In another embodiment of the invention, a method of enabling bid on manual services is proposed, the method comprises the steps of a) receiving service requests from one or more service request systems; b) displaying service requests to potential service providers; c) receiving service bids and security deposits from said service providers; d) sending service bids to said one or more service request systems; e) receiving selection result of service providers from said service request systems. Here, the service request system can be a computer system or computer network that connects with service requesters.

In one embodiment of the invention, a system for conducting a bid on a service is proposed, the system configured to a) receive service requests and payment from a customer that requests a service; b) display the service request to potential service providers; c) receive service bids and security deposits from said service providers; d) display bids to said customer; e) receive selection result of service provider from said customer.

In another embodiment of the invention, a system for conducting a bid on a service is proposed, the system configured to a) receive service requests and payments from a customer that requests a service; b) send service requests to one or more service systems so that potential service providers can see said service requests; c) receive service bids and security bids from said one or more service systems; d) display bids to said customer e) receive selection result of service providers from said customer; f) send the selection result to said one or more service systems.

In another embodiment of the invention, a system for conducting a bid on a service is proposed, the system configured to a) receive service requests from one or more service request systems; b) display service requests to potential service providers; c) receive service bids and security deposits from said service providers; d) send service bids to said one or more service request systems; and e) receive selection result of service providers from said service request systems.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

FIG. 1 is a block diagram illustrating an example network system 100 that may be used with various embodiments for providing online manual services. As shown in FIG. 1, the example network system 100 can comprise a bidding system 102, a service requester device 106, service provider devices 108-1 through 108-N (hereafter collectively referred to as “service provide devices 108”), and a computer network 104 communicatively coupling together the bidding system 102 each of the service requester device 106, and service provider devices 108. For illustrative purposes, the service requester device 106 will be understood to be used by a service requester user to access the bidding system 102, and each of the service provider client devices 108 will be understood to be ones used by service provider user to access the bidding system 102. It will be understood that for some embodiments, the components or the arrangement of components may differ from what is depicted in FIG. 1.

In accordance with some embodiments, the computer network 104 may be implemented or facilitated using one or more local or wide-area communications networks, such as the Internet, WFi networks, WiMax networks, private networks, public networks, and the like. Depending on the embodiment, some or all of the communication connections with the computer network 104 may utilize encryption (e.g., Secure Sockets Layer [SSL]) to secure information being transferred between the various entities shown in the example network system 100.

The bidding system 102, the service requester device 106, and each of the service provider devices 108 may be implemented in any computing devices computing devices may include a mobile phone, a tablet computing device, a laptop, a desktop computer, personal digital assistant, a portable gaming unit, a wired gaming unit, a thin client, a set-top box, a portable multi-media player, or any other type of touch-enabled computing device known to those of skill in the art. Further, the bidding system 102 may comprise one or more servers, which may be operating on or implemented using one or more cloud-based resources (e.g., System-as-a-Service [SaaS], Platform-as-a-Service [PaaS], or Infrastructure-as-a-Service [IaaS]). The service requester device 106 and each of the service provider devices 108 may comprise one or more servers, which may be operating on or implemented using one or more cloud-based resources (e.g., System-as-a-Service [SaaS], Platform-as-a-Service [PaaS], or Infrastructure-as-a-Service [IaaS]).

18.FIG. 2 shows the exemplary components of a bidding system 102, henceforth referred to as the system 102, according to an embodiment of the present subject matter. The system 102 is to provide manual services over a computer network. The system 102 can either be a portable electronic device, like laptop, notebook, netbook, tablet computer, etc., or a non-portable electronic device like desktop, workstation, server, etc. The system 102 includes a processor 202, processor 202 is coupled to a memory 204, a registration module 206, service request module 208, service management module 210, payment module 212, optional dispute resolution module 214, communication module 216, a bidding data 218 and other data 220 respectively.

The processor 202 can be implemented as one or more microprocessors, microcomputers, microcontrollers, digital signal processors, central processing units, state machines, logic circuitries, or any devices that manipulate signals based on operational instructions. Among other capabilities, the processor 202 can be configured to fetch and execute computer-readable instructions and data stored in the memory 204 respectively.

The memory 204 can include any computer-readable medium known in the art including, for example, volatile memory (e.g., RAM) and/or non-volatile memory (e.g., FLASH, etc.). The memory 204 include one or more modules which provide various functionalities to the system 102. The modules usually includes routines, programs, objects, components, data structure, etc. that perform particular task or implement particular abstract data types. The memory 204 also includes one or more data repository for storing data. The system 102 may also include other components required to provide additional functionalities to the system 102.

The registration module 206 is configured to allow the service requesters to avail access to the bidding system for the purposes of providing manual services. Service requester: can be service requester human being/organization, or can be another computer system that serves as intermediate network between the human being/organization and the bidding system. For this purpose, the registration module 206 may receive details, including email address and password, and optionally PayPal account information, bank details, etc., from the service requesters. The registration module 206 upon receipt of the details may send an email notification to the provided email address, thereby allowing the users to access the bidding system for availing online manual services. In an embodiment, the service requester may be provided access to the bidding system from corresponding media, such as, Facebook™, linkedIn™, Twitter™, Pininterest™, Tumblr™ or Instagram™ on authorization by the service requester. In such a scenario, the registration module 206 is configured to receive the details from the corresponding media, further to the authorization, and subsequently store these details in the bidding database.

The service request module 208 may be configured to generate one or more bid responses to a service requester, upon authorization. For this purpose, the service request module 208 is configured to receive a service request, from the service requester device. The service requester may be further requested to provide service request information associated with the service request. The service request information can include a service requirement, payment for service, service specifications, service instructions, service delivery date, expertise, purpose, language. For example, consider a scenario where a service requester would like to avail for translation service of a document. For this purpose, the service requester module 208 may receive the service request information that includes word count, professional level of the service required, minimum rating of the translator, date of manual service, format of the translated document, language to be translated, and the documents.

The service request module 208 may process the service request information and further send the processed service request information to potential service providers. The service provider is the people or organization who provides the service to the service requester. Similarly, service provider can be a human being/ organization that provides service or a computer system that serves as intermediate network between the human being/organization and the bidding system. In an embodiment, the selection of the potential service providers may be done by the service requester, from the service requester device.

In yet another embodiment, the service request module 208 may automatically determine potential service providers for the service based on the service request information. Each of the service providers provided by the service request module might be associated with information about service providers, e.g. a rating, field strength, sample translation file, and a short biography of the translators with the photo.

The service request module 208 in conjunction with the payments module 212 may receive security deposit and service bid information from the service providers for the service. The service bid information includes, but is not limited to, bidding statement, personal profile of the service providers, attachment files, and certificates. In an embodiment, the receipt of the security deposit and the service bid information is only under circumstances where the service provider is inclined to provide the service. In cases where the service provider is not inclined to participate in the bidding process, the service provider should not send security deposit or service bid information. For example, consider a scenario where the service requester would like to have a set of documents translated from English to Chinese in a short notice period. In the event, the service provider is unable to match the time frame or the language preference, the service provider may choose to decline participating in the bidding process and does not send either bid or security deposit.

In the event where the service provider is interested in participating in the bid process and confident in completing the service as required, the service provider shall express his interest in participating in the bidding process by payment of the security deposit, and providing the service bid information. The service request module 208 may be further configured to generate one or more bid requests/ service bid information in response to the service request information, to the service requester. In continuation with the previous example, the service request module 208 may process service bid information and send and display processed service bid information, for example, profile or CV of service provider, demo file that the service provider has worked on in the past, and a cover letter to the service requester, to the service requester to help the service requester to make the selection decision.

The service request module 208 may further receive a selection result of the service provider from the service requester. Such a selection result shall enable the service provider to perform the service in accordance with the quote and the service parameters.

The service management module 210 may be configured to manage a bid process for the desired service being requested by the user, which may include managing a bid request, one or more bid responses, one or more user responses, or current status associated with the bid process. Depending on the embodiment, management of the bid process can include modifying, controlling, canceling, duplicating, or deleting the bid process or various aspects thereof. For example, the service management module 210 may provide the current status (e.g., pending or completed) a bid process associated with the user and the service. The service management module 210 may permit the service requester to cancel or modify a bid process associated with the service. Additionally, the service management module 210 may permit the service provider user to cancel, modify or resubmit their bid response to a bid request or a user response associated with a bid process. Depending on the embodiment, the service management module 210 may manage storage of data relating to the bid process, which may include storage of data relating to or contained by a bid request, bid response, a user response, a service scheduling, or a pre-payment associated with the bid process. Data relating to or contained by a bid request, a bid response, a user response, a service scheduling, or a pre-payment associated with the bid process may be stored on the bidding database 218.

The payment module 212 may be configured to facilitate payment from the user to the service provider for the desired service. Payments that may be submitted through the payment module 212 can include, for example, PayPal, wire transfer, bank account, or the like. In an embodiment, the payments module may receive the security deposit from one or more service provides for the service desired by the service requester.

In an embodiment, the payments module 212 may refund the security deposit when the service requester cancels the service. For example, consider a scenario where the service requester requests for cancellation of the translation service prior to the start of service by the service provider. In such a scenario, the payments module 212 is configured to refund the security deposit to the service provider on cancellation of the service by the service requester.

In another embodiment, the payments module 212 may refund the security deposit if the service provider is not selected by the service requester. In yet another embodiment, the payments module 212 may refund the security deposit to the service provider when the service provider is selected by the service requester, and the service is rejected by the service provider. In yet another embodiment, the service provider selected by the service requester, and the service is completed. In an embodiment, the payments module 212 is configured to send an early payment to the service provider as soon as the service provider receives the selection for service by the service requester and confirms starting the service. For example, the service provider may receive a percentage of the total costs of the service as soon as the service provider is selected for the service by the service requester and sends confirmation of starting service to the bidding system.

In an embodiment, the payments module 212 is configured to receive implement steps of: receiving information, document, and material from said service provider, and further sending or displaying evaluation result of said service provider, wherein said evaluation result determines payment level of said service provider when providing services through the system. Consider a scenario where the payment level of a freelancer is to be determined. For this purpose, the freelancer may request for evaluation of his/her Curriculum Vitae (CV). For example, every freelancer needs to upload CV and request evaluation. The payment module 212 may further evaluate the technical levels of the freelancer, for instance, years of experience, skill set, professional education, etc., to determine the payment level. The payment level may evaluate the freelancer at a pre-determined frequency, to subsequently determine the payment level. For example, with more experience and good ratings, the technical levels of the freelancer can be increased and then the payment is increased accordingly.

Optionally, the bidding system may further include a dispute resolution module 214 to mediate disputes between a service provider and a service requester. The dispute resolution module 214 may settle disputes between the service provider and the service requester when the system is configured to receive request of rejecting service submitted by the service requester. The dispute resolution module 214 may further send the request of rejecting service to the service provider. At this point, the service provider may select one option from the group comprising accept the rejection and hire a mediator to settle the dispute. If the service provider chooses to accept the rejection, the dispute resolution module 214 notifies the service requester of the same, and the issue is closed. Then the service is rejected and cancelled. If however, the service provider decides to contest the rejection, the system notifies a mediator to mediate the online manual services between said service requester and said service provider. Other options may also be provided in the group that can be selected by the service provider in implementation. For example, another option that may be included in the group is X percent approval of rejection. If the service provider selects this X percent approval of rejection, the service provider will be paid only 1-X percent of the total payment for the service and the service requester will be refunded X percent of the payment for the service.

In an embodiment the system receives mediation fee from the service provider if hiring mediator is selected by the service provider. In an example, the dispute resolution module 214 may mediate disputes when the request for rejecting service can be only submitted only after the expected delivery date plus a timing offset.

The communication module 216 may be configured to facilitate communication between two or more users of the bidding system 102. In an embodiment, the user communication module 216 helps implement a secure and confidential communication medium between two or more users of the bidding system 102, which can include voice (e.g., phone call or voice chat), chat, messages, and exchange of information, which may be textual or multimedia in form.

In an embodiment, the communication module 216 may further send reminder emails to the service providers working on the desired service. For example, the communications module 216 may send reminder emails to translators working on the job at periodic intervals at a pre-determined frequency. In an embodiment, the communications module 216 may be configured to permit the user to submit a review or rating with respect to a desired service or the service provider. Depending on the embodiment, the communications module 216 may allow the user to submit the review or rating after the service provider has provided the user with the desired service.

Further, the communication module 216 can enable bid requests, bid responses, reviews, pre-payment, and the like to be exchanged between the service providers and the service requesters without need or use of an external communication system. In doing so, the user communication module 216 can allow the exchange of bid requests, bid responses, reviews, pre-payment, and the like to remain securely confined within the bidding system 102.

The bidding database 218 may be configured to implement or facilitate data storage with respect to various components of the bidding system 102, including data storage of service request information, information relating to a service requester, service provider, bid requests, security deposits, bid responses, counter bids, service reviews, reviews, pre-payment, in-system communication, notifications, and the like.

FIG. 3 is a flowchart illustrating a method for managing bid process for a desired service in accordance with an embodiment of the present subject matter. For this purpose, at block 302, service request information is received from a service requester. For this purpose, the service request module is configured to receive a service request, from the service requester device. The service requester may be further requested to provide service request information associated with the service request. The service request information can include a service requirement, payment for service, service specifications, service instructions, service delivery date, expertise, purpose, language. For example, consider a scenario where a service requester would like to avail for translation service of a document. For this purpose, the service requester module may receive the service request information that includes word count, professional level of the service required, minimum rating of the translator, date of manual service, format of the translated document, language to be translated, and the document.

At block 304, the processed service request information is sent to potential service providers. The service provider is the people or organization who provides the service to the service requester. In an embodiment, the selection of the potential service providers may be done by the service requester, from the service requester device. In yet another embodiment, the service request module may automatically determine potential service providers for the service based on the service request information. Each of the service providers provided by the service request module may be associated with a rating, field strength, sample translation file, and a short biography of the translators with the photo.

At block 306, the system receives security deposit and service bid information from the service providers for the service request. The service request module in conjunction with the payments module may receive security deposit and service bid information from the service providers for the service. The service bid information includes, but not limited to, bidding statement, personal profile of the service providers, attachment files, and certificates.

At block 308, the processed service bid information is sent to the service requester. The service request module 202 may be further configured to generate one or more bid requests/service bid information in response to the service request information, to the service requester. In continuation with the previous example, the service request module may display a profile and CV of the service provider, demo file that the service provider has worked on in the past, to the service requester to help the service requester make the selection decision.

At block 310, a selection result of the service provider is received from the service requester. Such a selection result shall enable the service provider to perform the service in accordance with the quote and the service parameters.

FIG. 4 is a flowchart mediating disputes for online manual services between a service requester and a service provider, in accordance with an embodiment of the present subject matter.

At block 402, a request for rejecting the services of the service provider is provided by the service requester. Such a request could be attributed for various reasons. For example, consider a situation where the service requester would like to have his documents translated from English to Chinese. It may so happen that the service requester may no longer be interested in pursuing the translation service after having agreed on the contract with the service provider. In such scenario, the service requester may choose to terminate the translation service with the service provider. Under such circumstances, the service requester may request for rejection, which means to cancel the service. In an embodiment, the dispute resolution module of the bidding system may receive the request. In an example, the dispute resolution module may mediate disputes when the request for rejecting service can be only submitted only after the expected delivery date plus a timing offset.

At block 404, the request for rejecting the services by the service requester is notified to the service provider. In continuation with the previous example, the dispute resolution module may notify the service provider of the service requester's intent to cancel the service.

At block 406, a selection result selected from the group comprising approving rejection and hiring mediator is selected by the service provider. In an example, the service provider may choose to hire a mediator when he suffers a monetary loss or any other such losses upon such a request made by the service requester. For instance, the service provider may have already initiated work on the project, and any such cancellation of the service after the initiation of the work may result in monetary loses to the service provider. In such cases, the service provider may choose to hire a mediator to settle the dispute between the service requester and the service provider.

At block 408, the service provider approves of the rejection of the service. This may happen if the service provider has not initiated work on the service requested by the service requester or wants to avoid dispute mediation.

At block 410, a hiring mediator is selected by the service provider, to mediate disputes between the service provider and the service requester. The dispute resolution module may notify the service requester of the same. For instance, the service provider may have already initiated work on the project, and any such cancellation of the service after the initiation of the work may result in monetary loses to the service provider. In such cases, the service provider may choose to hire a mediator to settle the dispute between the service requester and the service provider. Optionally, the service provider may need to pay a mediation fee if the service provider selects hiring a mediator.

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Industrial Applicability

The invention has application at least to the information and communication technology industry.

1-20. (canceled)

21. A method for automatically efficiently providing online manual services comprising:
a. receiving service request information from a service requester;
b. sending processed service request information to only potential rated service providers;
c. receiving both mandatory security deposit and service bid information from the rated service providers for the service request;
d. sending processed service bid information to the service requester;
e. receiving selection result of service provider from the service requester;
f. sending the selection result of service provider to the rated service providers;
wherein the rated service providers are only the service providers that have submitted information, document and material to the system for evaluation, have passed the evaluation, and have received evaluation result from the system,
wherein the evaluation result determines payment rate of the service provider when providing services through a system of the method for automatically efficiently providing online manual services, wherein the rated service provider that has been selected may choose to either Start or Cancel service upon receiving the selection result, wherein the method further includes sending the rated service provider that has been selected to perform the service an early payment after the rated service provider has received the selection result for service provision and has started the service, wherein for the service that has been started by the rated service provider that has been selected, the method further comprises:
g. receiving request of rejecting service submitted by the service requester;
h. sending request of rejecting service to the rated service provider; and
i. receiving from the rated service provider the selection result selected from the group comprising approving rejection and hiring mediator.

22. The method for providing online manual services as claimed in claim 21, wherein the online manual services can be selected from all the manual services which can be provided online, wherein the service request information is selected from the group comprising service requirement, payment for service, service specifications, service instructions, service delivery date, expertise, purpose, language, wherein the service bid information is selected from the group comprising bidding statement, personal profile of people providing service, attachment files, certificates, resume, and curriculum vitae.

23. The method for providing online manual services as claimed in claim 21, wherein the service requester is a request system that connects people or organization who request manual service and exchanges information between the people or organization and the system of the method for providing online manual services.

24. The method for providing online manual services as claimed in claim 23, wherein the online manual services can be selected from all the manual services which can be provided online, wherein the service request information is selected from the group comprising service requirement, payment for service, service specifications, service instructions, service delivery date, expertise, purpose, language, wherein the service bid information is selected from the group comprising bidding statement, personal profile of people providing service, attachment files, certificates, resume, and curriculum vitae.

25. The method for providing online manual services as claimed in claim 21, wherein the service provider is a provision system that connects people or organization who provide manual service and exchange information between the people and the system of the method for automatically efficiently providing online manual services.

26. The method for providing online manual services as claimed in claim 25, wherein the online manual services can be selected from all the manual services which can be provided online; the service request information is selected from the group comprising service requirement, payment for service, service specifications, service instructions, service delivery date, expertise, purpose, language; and the service bid information is selected from the group comprising bidding statement, personal profile of people providing service, attachment files, certificates, resume, curriculum vitae.

27. The method for providing online manual services as claimed in claim 21, wherein the mandatory security deposit is refunded to the service provider when one of the following happens:
the service requester cancels the service,
the service provider is not selected by the service requester,
the service provider is selected by the service requester and the service is approved rejected by the service provider,
the service provider is selected by the service requester and the service is approved completed by the service requester.

28. The method for providing online manual services as claimed in claim 21, wherein the request of rejecting service can only be submitted after the expected delivery date plus a timing offset.

29. The method for providing online manual services as claimed in claim 21, wherein the system receives mediation fee from the service provider if hiring mediator is selected by the service provider, wherein the method further comprises:
a. canceling the service upon receiving the selection of approving rejection is received from the service provider, and
b. notifying a mediator to mediate the online manual services between the service requester and the service provider upon the selection of hiring mediator from the service provider.

30. A method for providing online manual services, wherein the method comprises:
a. receiving service request information from a service requester;
b. sending processed service request information to potential service providers;
c. receiving security deposit and service bid information from the service providers for the service request;
d. sending processed service bid information to the service requester; and
e. receiving selection result of service provider from the service requester.

31. The method for providing online manual services as claimed in claim 30, wherein the online manual services can be selected from all the manual services which can be provided online, wherein the service request information is selected from the group comprising service requirement, payment for service, service specifications, service instructions, service delivery date, expertise, purpose, and language, wherein the service bid information is selected from the group comprising bidding statement, personal profile of people providing service, attachment files, certificates, resume, and curriculum vitae.

32. The method for providing online manual services as claimed in claim 30, wherein the service requester is the people or organization who request manual service, wherein the service request information is selected from the group comprising service requirement, payment for service, service specifications, service instructions, service delivery date, expertise, purpose, and language.

33. The method for providing online manual services as claimed in claim 30, wherein the service requester is a request system that connects people or organization who request manual service and exchanges information between the people or organization and a system of the method for providing online manual services, wherein the service request information is selected from the group comprising service requirement, payment for service, service specifications, and service instructions.

34. The method for providing online manual services as claimed in claim 30, wherein the service provider is the people or organization who provide manual service, wherein the service provider is a provision system that connects people or organization who provide manual service and exchange information between the people and a system of the method for providing online manual services.

35. The method for providing online manual services as claimed in claim 30, wherein the security deposit is refunded to the service provider when one of the following happens:
the service requester cancels the service,
the service provider is not selected by the service requester,
the service provider is selected by the service requester and the service is approved rejected by the service provider, and
the service provider is selected by the service requester and the service is approved completed by the service requester.

36. The method for providing online manual services as claimed in claim 30, wherein the system for providing online manual services would send the service provider an early payment as soon as the service provider receives the selection for service by the service requester and starts the service.

37. The method for providing online manual services as claimed in claim 30 further comprising:
receiving information, document, and material from the service provider, and
sending or displaying evaluation result of the service provider to the service provider, wherein the evaluation result determines payment level of the service provider when providing services through a system of the method for providing online manual services.

38. A method for mediating disputes for online manual services between a service requester and a service provider comprising:
a. receiving a request of rejecting service submitted by the service requester;
b. sending or displaying the request of rejecting service to the service provider;
c. receiving a selection result selected from the group comprising approving rejection and hiring mediator selected by the service provider.

39. The method for mediating disputes for online manual services between a service requester and a service provider as claimed in claim 38, wherein the request of rejecting service can only be submitted after the expected delivery date plus a timing offset.

40. The method for mediating disputes for online manual services between a service requester and a service provider as claimed in claim 38, further comprising receiving a mediation fee from the service provider if hiring mediator is selected by the service provider, wherein the method further comprises:
a. canceling the service upon receiving the selection of approving rejection is received from the service provider, and
b. notifying a mediator to mediate the online manual services between the service requester and the service provider upon the selection of hiring mediator from the service provider. 21 1
